(19) United States
(12) Patent Application Publication
(10) Pub. No.: US 2026/0220077 A1
(43) Pub. Date: Jul. 30, 2026

(54) WORKLOAD PARTITIONING FOR DUAL SYSTEM ON A CHIP (SOC)

(71) Applicant: QUALCOMM Incorporated, San Diego, CA (US)

(72) Inventors: Shruti HANUMANTHAIAH, Bangalore (IN); Subbarao LANKA, Bangalore (IN)

(21) Appl. No.: 19/037,608

(22) Filed: Jan. 27, 2025

(51) Int. Cl. G06F 15/78

(52) U.S. Cl. CPC G06F 15/7807

(57) ABSTRACT

Aspects of the disclosure are directed to system on a chip (SOC) workload partitioning. In accordance with one aspect, the disclosure includes determining if an initial system on a chip (SOC) configuration is a single SOC configuration; determining if a master system on a chip (SOC) is a master fast-fast (FF) carrier mobility case or a master slow-slow (SS) carrier mobility case; and determining if a slave system on a chip (SOC) is a slave typical-typical (TT) carrier mobility case.

### TECHNICAL FIELD

This disclosure relates generally to the field of information processing systems, and, in particular, to workload partitioning for a dual system on a chip (SOC) configuration

### BACKGROUND

Information processing systems may include multiple processing engines, processors or processing cores for a variety of user applications. An information processing system may include a central processing unit (CPU), a graphics processing unit (GPU), a digital signal processor (DSP), an image signal processor (ISP), a neural processing unit (NPU), etc., along with input/output interfaces, a hierarchy of memory units and associated interconnection databuses. In addition, the information processing system may include a plurality of peripheral devices which communicate with a processing engine using a plurality of high-speed interfaces. In one example, the information processing system may include a plurality of system on a chip (SOC) devices wherein each SOC device hosts a plurality of processing engines within a single chip. For efficient dc power operation, the partitioning of workload among the plurality of SOCs should be optimized to minimize dc power consumption for increased battery operational duration.

### SUMMARY

The following presents a simplified summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later.

In one aspect, the disclosure provides system on a chip (SOC) workload partitioning. Accordingly, the present disclosure discloses a method including: determining if an initial system on a chip (SOC) configuration is a single SOC configuration; determining if a master system on a chip (SOC) is a master fast-fast (FF) carrier mobility case or a master slow-slow (SS) carrier mobility case; and determining if a slave system on a chip (SOC) is a slave typical-typical (TT) carrier mobility case.

Another aspect of the disclosure provides an apparatus including: a non-transitory memory unit configured to store a master workload and a slave workload; a slave system on a chip (SOC) coupled to the non-transitory memory unit, the slave SOC configured to process the slave workload; and a master system on a chip (SOC) coupled to the non-transitory memory unit, the master SOC configured to determine if the master SOC is a master fast-fast (FF) carrier mobility case or a master slow-slow (SS) carrier mobility case and further configured to determine if the slave SOC is a slave typical-typical (TT) carrier mobility case.

Another aspect of the disclosure provides an apparatus including: means for determining if a master system on a chip (SOC) with a master workload is a master typical-typical (TT) carrier mobility case; means for determining if a slave system on a chip (SOC) with a slave workload is a slave typical-typical (TT) carrier mobility case; means for determining if an initial system on a chip (SOC) configuration is a single SOC configuration; means for determining if the master SOC is a master fast-fast (FF) carrier mobility case or a master SS carrier mobility case; means for determining if the slave SOC is the slave TT carrier mobility case; means for determining if the master SOC is the master TT carrier mobility case; means for determining if the slave SOC is a slave SS carrier mobility case or a slave fast-fast (FF) carrier mobility case; and means for moving a portion of the slave workload to the master SOC to operate on an augmented master workload.

These and other aspects of the present disclosure will become more fully understood upon a review of the detailed description, which follows. Other aspects, features, and implementations of the present disclosure will become apparent to those of ordinary skill in the art, upon reviewing the following description of specific, exemplary implementations of the present invention in conjunction with the accompanying figures. While features of the present invention may be discussed relative to certain implementations and figures below, all implementations of the present invention can include one or more of the advantageous features discussed herein. In other words, while one or more implementations may be discussed as having certain advantageous features, one or more of such features may also be used in accordance with the various implementations of the invention discussed herein. In similar fashion, while exemplary implementations may be discussed below as device, system, or method implementations it should be understood that such exemplary implementations can be implemented in various devices, systems, and methods.

### BRIEF DESCRIPTION OF THE DRAWINGS

FIG. 1 illustrates an example information processing system.

FIG. 2 illustrates an example dual system on a chip (SOC) augmented reality (AR) system.

FIG. 3 illustrates an example dual system on a chip (SOC) virtual reality (VR) system.

FIG. 4 illustrates an example dc power consumption table for a part-based use case.

FIG. 5 illustrates a first example process variation scenario.

FIG. 6 illustrates a second example process variation scenario.

FIG. 7 illustrates a third example process variation scenario.

FIG. 8 illustrates an example dc power consumption table for a virtual reality (VR) use case.

FIG. 9 illustrates an example system on a chip (SOC) workload partitioning logic diagram.

FIG. 10 illustrates an example flow diagram for implementing system on a chip (SOC) workload partitioning.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

While for purposes of simplicity of explanation, the methodologies are shown and described as a series of acts, it is to be understood and appreciated that the methodologies are not limited by the order of acts, as some acts may, in accordance with one or more aspects, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with one or more aspects.

An information processing system, for example, a computing system with multiple slices (e.g., processing engines) or a system on a chip (SOC), uses multiple levels of coordination or synchronization. In one example, a slice may include a processing engine (i.e., a subset of the computing system) as well as SOC associated memory units and other peripheral devices. In one example, execution of an application may be decomposed into a workload which is executed by multiple slices or multiple processing engines. In one example, the workload is comprised of a plurality of tasks. In one example, a workload shift is a movement of a portion of the workload from one processing engine to another.

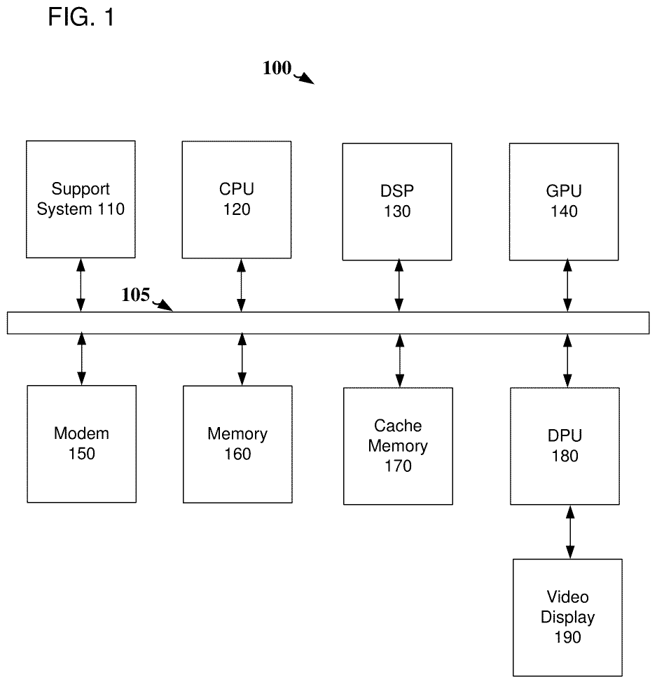

FIG. 1 illustrates an example information processing system 100. In one example, the information processing system 100 includes a plurality of processing engines such as a central processing unit (CPU) 120, a digital signal processor (DSP) 130, a graphics processing unit (GPU) 140, a display processing unit (DPU) 180, etc. In one example, various other functions in the information processing system 100 may be included such as a support system 110, a modem 150, a memory 160, a cache memory 170 and a video display 190. For example, the plurality of processing engines and various other functions may be interconnected by an interconnection databus 105 to transport data and control information. In one example, the CPU 120 may serve as a controller or a microcontroller of other processing engines. In one example, the controller or microcontroller may reallocate tasks from one processing engine to another.

In one example, the memory 160 and/or the cache memory 170 may be shared among the CPU 120, the GPU 140 and the other processing engines. In one example, the CPU 120 may include a first internal memory which is not shared with the other processing engines. In one example, the GPU 140 may include a second internal memory which is not shared with the other processing engines. In one example, any processing engine of the plurality of processing engines may have an internal memory (i.e., a dedicated memory) which is not shared with the other processing engines. Although several components of the information processing system 100 are included herein, one skilled in the art would understand that the components listed herein are examples and are not exclusive. Thus, other components may be included as part of the information processing system 100 within the spirit and scope of the present disclosure.

In one example, one or more processing engines in the information processing system 100 may be aggregated into a single integrated circuit known as a system on a chip (SOC). In one example, the SOC may include the central processing unit (CPU) 120 and other processing engines such as the DSP 130 or the GPU 140. The SOC may also include the memory 160 and the cache memory 170.

In one example, the information processing system 100 may be part of a wireless device in a wireless communication system. For example, the wireless communication system may conform to a wireless network protocol such as 4G LTE (long term evolution), 5G NR (new radio), etc.

In one example, an information processing system may include augmented reality (AR) devices or virtual reality (VR) devices. For example, the AR devices or VR devices (e.g., smart glasses (SG)) may employ batteries with limited capacity (e.g., 150 to 500 milliAmpere-Hours capacity).

In one example, an AR device may have a very low thermal power envelope (TPE) (i.e., they require very low dc power consumption and low thermal dissipation). For example, the AR device may include a SOC, a power management integrated circuit (PMIC) and a dynamic random access memory (DRAM). In one example, smart glasses with an AR viewer may require less than 500 mW power consumption, an AR viewer may require less than 900 mW power consumption and AR goggles may require less than 1500 mW power consumption.

In one example, minimization of dc power consumption (e.g., even a few mW) is important since device form factor is small and the battery size must be minimized. In one example, a VR headset, even with a relatively high TPE (e.g., near 15 W), requires a low dc power consumption to optimize form factor size by reduction of battery size so that a lighter headset with extended usage duration is attained. Hence, power optimization and thermal distribution are critical requirements for AR devices, VR devices and smart glasses. However, evolving use cases result in enhanced performance needs as AR devices and VR devices proliferate.

In one example, one design approach to address form factor requirements, thermal distribution needs and enhanced performance goals is a distributed processing architecture with dual or multiple SOCs. For example, usage of dual SOCs improves mass distribution in the case of VR headsets. For example, a dual SOC architecture incurs a power overhead while improving power and thermal distribution with performance enhancement. For example, the dual SOC architecture consumes more dc power than a single SOC architecture. Thus, a dual SOC architecture requires dc power optimization. One dc power optimization technique relies on an intelligent power optimization approach in a dual SOC architecture.

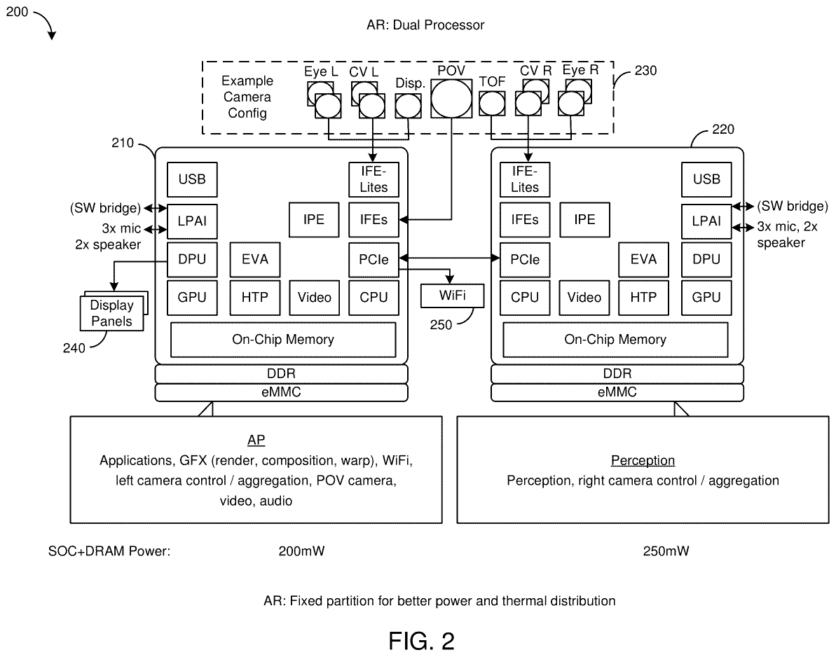

FIG. 2 illustrates an example dual system on a chip (SOC) augmented reality (AR) system 200. In one example, the dual SOC AR system 200 includes a first SOC 210, a second SOC 220, a camera configuration 230, a plurality of display panels 240 and a wireless modem (e.g., WiFi modem) 250.

In one example, the first SOC 210 and the second SOC 220 each include a plurality of processing engines (e.g., central processing unit (CPU), graphical processing unit (GPU), display processing unit (DPU), etc.), a plurality of interface devices (e.g., universal serial bus (USB), peripheral component interconnect express (PCIe), interface Ethernet (IFE), etc., on-chip memory (e.g., double data rate (DDR) memory) and an embedded multimedia card (eMMC). For example, the first SOC 210 and the second SOC 220 may each include a software (SW) bridge, a microphone interface and a speaker interface.

In one example, the dual SOC AR system 200 may partition its workload between the first SOC 210 and the second SOC 220. For example, the first SOC 210 may handle basic operations (e.g., rendering, composition, warping, video, audio, etc.) and the second SOC 220 may handle more intensive operations (e.g. perception). In one example, the workload partition may be fixed between the first SOC 210 and the second SOC 220 for improved dc power and thermal dissipation distribution across the dual SOC AR system 200. For example, aggregate dc power consumption is higher with dual SOC operation vs. single SOC operation, so optimization of the dual SOC operation is important for improved performance and capability.

In one example, the camera configuration 230 includes a plurality of camera interface modules. In one example, the plurality of display panels 240 are used for display of graphical outputs and other application data for a user. In one example, the wireless modem 250 is used for communications connectivity with external networks (e.g., the Internet) using a wireless protocol (e.g., WiFi or IEEE 802.11).

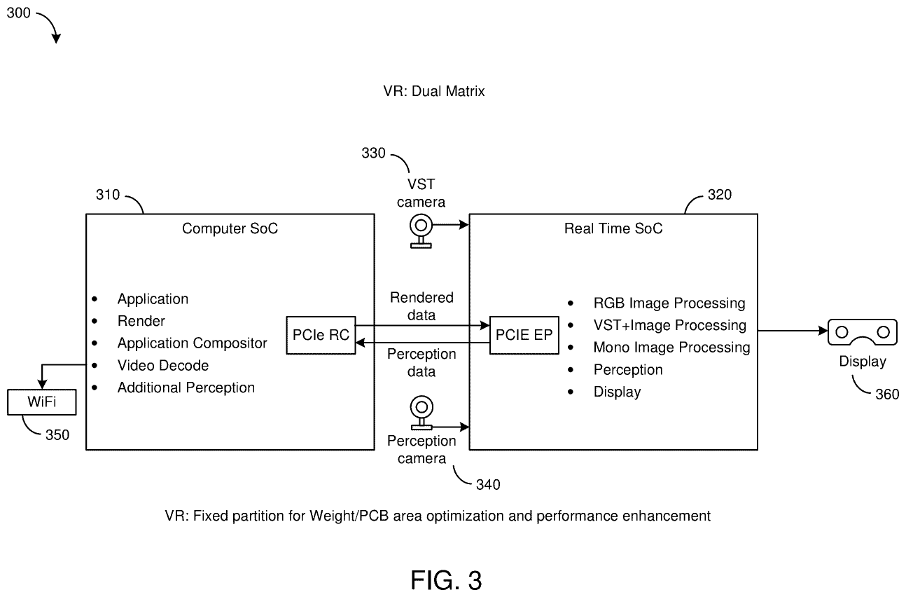

FIG. 3 illustrates an example dual system on a chip (SOC) virtual reality (VR) system 300. In one example, the dual SOC VR system 300 includes a first SOC 310, a second SOC 320, a visual see-through (VST) camera 330, a perception camera 340, a wireless modem (e.g., WiFi modem) 350 and a display 360.

In one example, the dual SOC VR system 300 may partition its workload between the first SOC 310 and the second SOC 320. For example, the first SOC 310 may handle generic processing tasks (e.g., rendering, composition, video decoding, etc.) and the second SOC 320 may handle more intensive processing tasks (e.g., image processing, perception, display, etc.). In one example, the workload partition may be fixed between the first SOC 310 and the second SOC 320 for better dc power and thermal dissipation distribution across the dual SOC VR system 300. For example, the workload partition may be based on optimization of printed circuit board (PCB) area and overall mass while achieving desired performance goals.

In one example, carrier mobility μ is an electrical parameter describing carrier drift speed for a given electric field in a semiconductor. For example, a carrier is a charged particle (e.g., electron or hole) in the semiconductor. In one example, the carrier mobility μ is proportional to a mean free time (i.e., average time between collisions) of the carrier. For example, a higher carrier drift speed yields a higher device operational speed and a lower carrier drift speed yields a lower device operational speed. In one example, carrier drift speed v_{d} (in units of m/s) is related to electric field E (in units of V/m) by the equation:

v_{d}=μE,

where carrier mobility μ is in units of m²/Vs.

For example, a fast carrier mobility results in a fast carrier drift speed. For example, a typical carrier mobility results in a typical carrier drift speed. For example, a slow carrier mobility results in a slow carrier drift speed. For example, a typical carrier mobility for an electron carrier in silicon is approximately 1000 cm²/V s. For example, a typical carrier mobility for a hole carrier in silicon is approximately 500 cm²/V s. For example, a range of carrier mobility (values) may be specified by a carrier mobility probability distribution (i.e., a probability distribution of carrier mobility (values)).

In one example, the carrier mobility probability distribution includes two statistical parameters: a mean (i.e., a first moment of the probability distribution) and a standard deviation (i.e., square root of a second moment of the probability distribution minus square of the mean). For example, if the carrier mobility probability distribution is a Gaussian distribution, 68% of samples of the carrier mobility value are expected to be bounded between the mean plus and minus the standard deviation (i.e., between mean±standard deviation). For example, for the Gaussian distribution 16% of samples are expected to be less than one negative standard deviation from the mean and 16% of samples are expected to be greater than one positive standard deviation from the mean. Thus, the standard deviation may be used as a characterization threshold for values which follow the Gaussian probability distribution.

In one example, a semiconductor may be characterized with a carrier mobility case to describe a relative carrier mobility value within the carrier mobility probability distribution. For example, the carrier mobility probability distribution describes a variation of carrier mobility (values) with statistical characterization parameters such as mean and standard deviation. For example, a semiconductor may be characterized as a fast (F) carrier mobility case if its carrier mobility is significantly higher (e.g., greater than three positive standard deviations higher) than a mean of the carrier mobility probability distribution. For example, a semiconductor may be characterized as a slow (S) carrier mobility case if its carrier mobility is significantly lower (e.g., less than three negative standard deviations lower) than a mean of the carrier mobility probability distribution. For example, a semiconductor may be characterized as a typical (T) carrier mobility case if its carrier mobility is approximately a mean of the carrier mobility probability distribution (e.g., within plus or minus one standard deviation of the mean).

In one example, a semiconductor may be denoted with a semiconductor type to describe a particular semiconductor device implementation. For example, a semiconductor type may be an n-channel metal oxide semiconductor (NMOS) type or a p-channel metal oxide semiconductor (PMOS). For example, a nomenclature of FF may denote a first semiconductor type as a fast carrier mobility case and a second semiconductor type as a fast carrier mobility case. For example, a nomenclature of TT may denote a first semiconductor type as a typical carrier mobility case and a second semiconductor type as a typical carrier mobility case. For example, a nomenclature of FS may denote a first semiconductor type as a fast carrier mobility case and a second semiconductor type as a slow carrier mobility case.

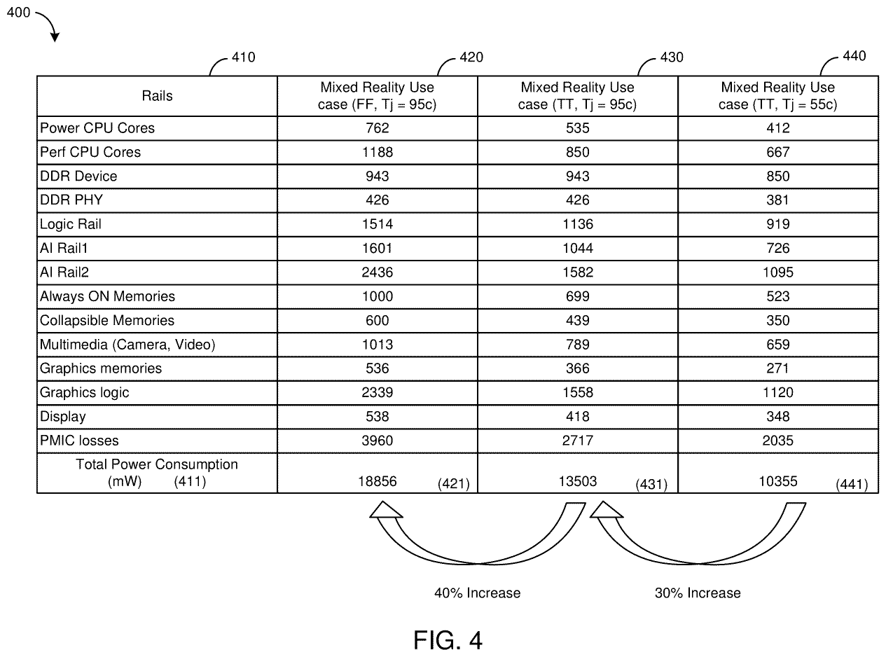

FIG. 4 illustrates an example dc power consumption table for a part-based use case 400. In one example, the dc power consumption table 400 shows three different dc power consumption mixed reality use cases for different semiconductor carrier mobility cases and different temperatures: a fast-fast (FF) hot temperature use case 420, a typical-typical (TT) hot temperature use case 430 and a typical-typical (TT) nominal temperature use case 440 for a plurality of rails 410. In one example, the dc power consumption table 400 is presented for a design using a first semiconductor type (e.g., NMOS) and a second semiconductor type (e.g., PMOS).

In a first example, the fast-fast (FF) hot temperature use case 420 represents a first semiconductor scenario at a hot temperature (e.g., 95 deg C.) with a first semiconductor type at a fast carrier mobility case and a second semiconductor type at a fast carrier mobility case. In a second example, the typical-typical (TT) hot temperature use case 430 represents a second semiconductor scenario at a hot temperature (e.g., 95 deg C.) with a first semiconductor type at a typical carrier mobility case and a second semiconductor type at a typical carrier mobility case. In a third example, the typical-typical (TT) typical temperature use case 440 represents a third semiconductor scenario at a nominal temperature (e.g., 55 deg C.) with a first semiconductor type at a typical carrier mobility case and a second semiconductor type at a typical carrier mobility case. In one example, the different dc power consumption mixed reality use cases may be used to highlight dc power consumption differences among different semiconductor scenarios.

In one example, a semiconductor scenario describes a combination of carrier mobility cases (i.e., fast, typical or slow) for two semiconductor types and a temperature level (hot or nominal). In one example, there are five relevant carrier mobility cases (or part corners): typical-typical (TT), fast-fast (FF), slow-slow (SS), fast-slow (FS) and slow-fast (SF). For example, FF and SS parts may consume higher dc power than TT parts due to process variations.

FIG. 4 tabulates total dc power consumption 411 in milliwatts for three dc power consumption mixed reality use cases. In one example, the FF hot temperature use case 420 tabulates a first dc power consumption 421 of 18 856 mW. In one example, the TT hot temperature use case 430 tabulates a second dc power consumption 431 of 13 503 mW. In one example, the TT nominal temperature use case 440 tabulates a third dc power consumption 441 of 10 355 mW. For example, dc power consumption increases approximately 30% from the third semiconductor scenario to the second semiconductor scenario. For example, dc power consumption increases approximately 40% from the second semiconductor scenario to the first semiconductor scenario.

In one example, a dual SOC configuration may operate in a variety of carrier mobility cases (i.e., due to semiconductor process variations). For example, a first SOC may be in a fast-fast (FF) carrier mobility case and a second SOC may be in a typical-typical (TT) carrier mobility case. For example, the first SOC in the FF carrier mobility case consumes more dc power than the second SOC in the TT carrier mobility case. For example, in this scenario, a workload shift from the first SOC to the second SOC may result in an overall reduction in dc power consumption due to the differential power consumption of different carrier mobility cases.

In one example, one SOC in a plurality of SOCs may operate as a master SOC and be responsible for configuration management for the plurality of SOCs. For example, the master SOC may incorporate carrier mobility case information for the plurality of SOCs. For example, the carrier mobility case information may be stored in memory at the master SOC.

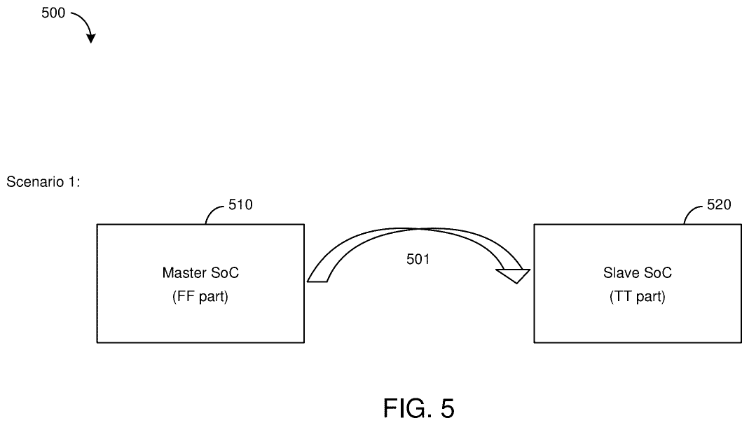

FIG. 5 illustrates a first example process variation scenario 500. In one example, the process variation scenario 500 includes a first SOC 510 in an FF carrier mobility case and a second SOC 520 in a TT carrier mobility case. For example, the first SOC 510 may operate as a master SOC with a master workload 501 and the second SOC 520 may operate as a slave SOC. In one example, the second SOC 520 is initially in an inactive state. In one example, the first SOC 510 determines the carrier mobility case of the second SOC 520 and compares it to the carrier mobility case of the first SOC 510. In one example, the first SOC 510 moves a portion of the master workload 501 to the second SOC 520 based on the carrier mobility cases if dc power savings resulting from the movement is greater than dc power overhead of the second SOC 520.

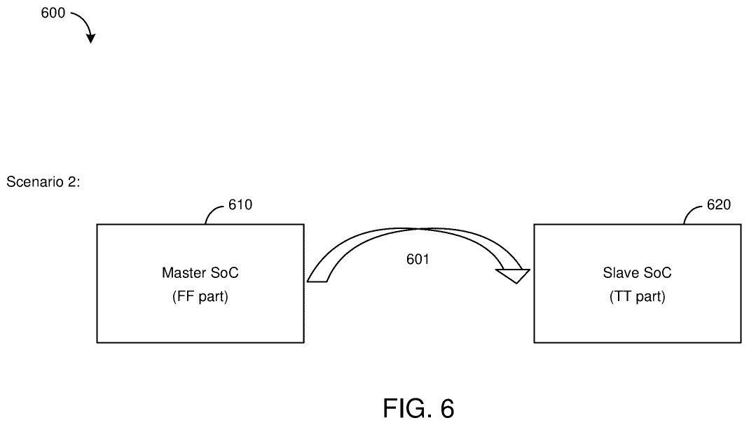

FIG. 6 illustrates a second example process variation scenario 600. In one example, the process variation scenario 600 includes a first SOC 610 in an FF carrier mobility case and a second SOC 620 in a TT carrier mobility case. For example, the first SOC 610 may operate as a master SOC with a master workload 601 and the second SOC 620 may operate as a slave SOC with a slave workload. In one example, the first SOC 610 and the second SOC 620 are initially in a fixed partition state where the master workload 601 and the slave workload are fixed independent of SOC design details. In one example, the first SOC 610 determines the carrier mobility case of the second SOC 620 and compares it to the carrier mobility case of the first SOC 610. In one example, the first SOC 610 moves a portion of the master workload 601 to the second SOC 620 based on the carrier mobility cases if dc power savings resulting from the movement is greater than dc power overhead of the second SOC 620.

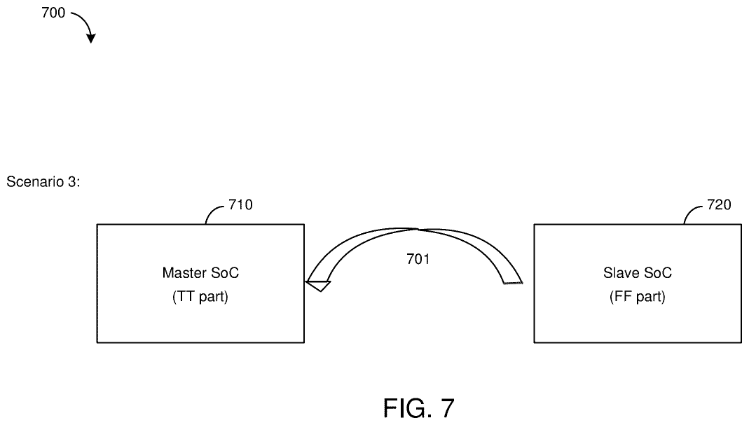

FIG. 7 illustrates a third example process variation scenario 700. In one example, the process variation scenario 700 includes a first SOC 710 in an TT carrier mobility case and a second SOC 720 in a FF carrier mobility case. For example, the first SOC 710 may operate as a master SOC with a master workload and the second SOC 720 may operate as a slave SOC with a slave workload. In one example, the first SOC 710 and the second SOC 720 are initially in a fixed partition state where the master workload and the slave workload are fixed independent of SOC design details.

In one example, the first SOC 710 determines the carrier mobility case of the second SOC 720 and compares it to the carrier mobility case of the first SOC 710. In one example, the first SOC 710 moves a portion of the slave workload 701 to the first SOC 710 based on the carrier mobility cases if dc power savings resulting from the movement is greater than dc power overhead of the first SOC 710. In one example, the first SOC 710 moves all of the slave workload 701 to the first SOC 710 based on the carrier mobility cases if dc power savings resulting from the movement is greater than dc power overhead of the first SOC 710 and if performance with only the first SOC 710 can be met.

In one example, the process variation scenarios illustrated in FIG. 5, FIG. 6 and FIG. 7 may be extended to other scenarios. For example, other process variation scenarios may include a SOC in a SS carrier mobility case in addition to the FF carrier mobility case and the TT carrier mobility case.

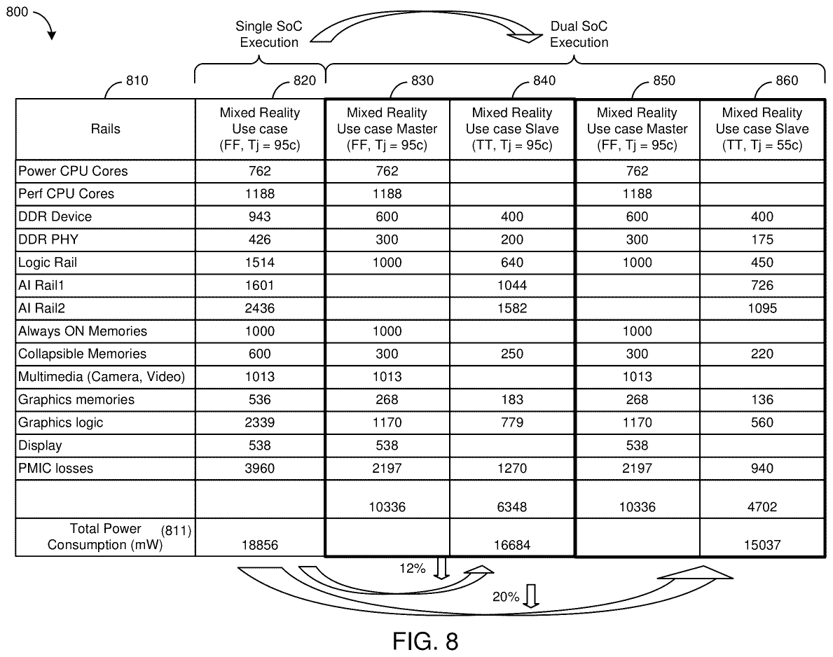

FIG. 8 illustrates an example dc power consumption table 800 for a virtual reality (VR) use case. In one example, the dc power consumption table 800 shows five different dc power consumption mixed reality use cases for different semiconductor carrier mobility cases and different temperatures. In one example, the dc power consumption table 800 applies for a single SOC configuration and a dual SOC configuration. In one example, the five different dc power consumption mixed reality use cases are: a fast-fast (FF) hot temperature use case for a single SOC in a single SOC configuration 820, a fast-fast (FF) hot temperature use case for a master SOC in a dual SOC configuration 830, a typical-typical (TT) hot temperature use case for a slave SOC in a dual SOC configuration 840, a fast-fast (FF) hot temperature use case for a master SOC in a dual SOC configuration 850 and a typical-typical (TT) nominal temperature use case for a slave SOC in a dual SOC configuration 860 for a plurality of rails 810. In one example, the dc power consumption table 800 is presented for a design using a first semiconductor type (e.g., NMOS) and a second semiconductor type (e.g., PMOS).

In one example, the single SOC configuration (i.e., the FF hot temperature use case for a single SOC in a single SOC configuration 820) has a high dc power consumption of 18.856 W with an FF carrier mobility case. In one example, in a dual SOC configuration, the slave SOC has a TT carrier mobility case, and the master SOC may move a portion of its workload to the slave SOC to reduce dc power consumption. For example, with the workload movement, the slave SOC may be at a temperature lower than 95 deg C., depending on the workload movement.

In one example, the dc power consumption may be reduced by 12% (i.e., from 18856 mW to 16684 mW) if the slave SOC is in a TT carrier mobility case at a hot temperature (e.g., 95 deg C.) and if there is a workload movement from the master SOC to the slave SOC (i.e., the TT hot temperature use case for a slave SOC in a dual SOC configuration 840). In one example, the dc power consumption may be reduced by 20% (i.e., from 18856 mW to 15037 mW) if the slave SOC is in a TT carrier mobility case at a nominal temperature (e.g., 55 deg C.) and if there is a workload movement from the master SOC to the slave SOC (i.e., the TT nominal temperature use case for a slave SOC in a dual SOC configuration 860). In one example, the dc power reduction occurs with the slave SOC in the TT carrier mobility case and with further dc power reduction with the slave SOC at the nominal temperature vs. the hot temperature.

In one example, the dc power reduction illustrated in FIG. 8 is significant since it allows an increased device usage time. Alternatively, the dc power reduction allows a smaller battery form factor with reduced device mass for the same device usage time (i.e., prior to battery recharging).

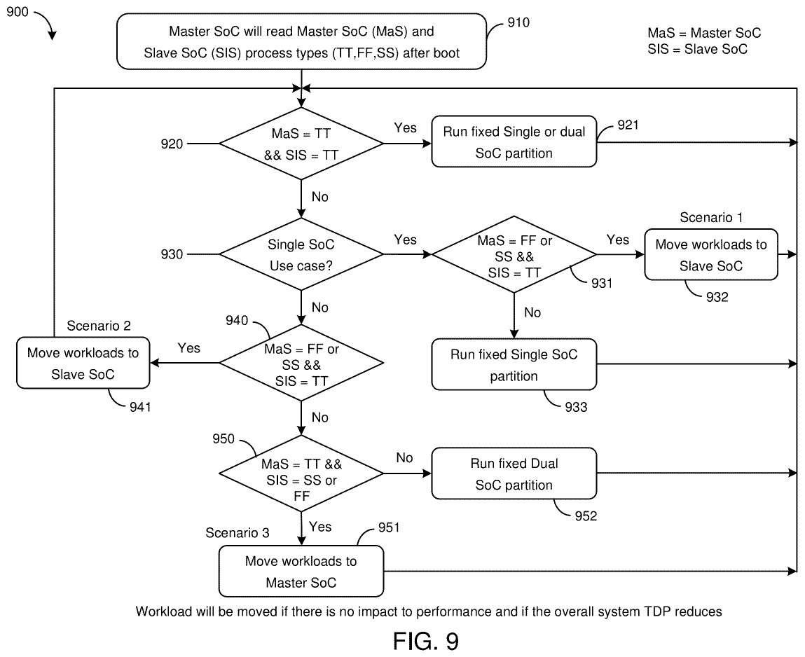

FIG. 9 illustrates an example system on a chip (SOC) workload partitioning logic diagram 900. In one example, a portion of a workload may be moved from one SOC to another SOC if there is no performance impact and if temperature distribution is lowered.

In block 910, determine a master SOC carrier mobility case and a slave SOC carrier mobility case while in an initial SOC configuration prior to a SOC operational mode. In one example, the initial SOC configuration is a fixed single SOC configuration or a fixed dual SOC configuration. In one example, the master SOC carrier mobility case may be a fast-fast (FF) carrier mobility case, a typical-typical (TT) carrier mobility case or a slow-slow (SS) carrier mobility case. In one example, the slave SOC carrier mobility case may be the fast-fast (FF) carrier mobility case, the typical-typical (TT) carrier mobility case or the slow-slow (SS) carrier mobility case. In one example, the determination is achieved by retrieving carrier mobility case data from a memory. In one example, the memory is a bootup memory (e.g., read only memory (ROM)).

In block 920, determine if the master SOC with a master workload is a TT carrier mobility case and the slave SOC with a slave workload is a TT carrier mobility case. If yes, proceed to block 921. If no, proceed to block 930.

In block 921, commence SOC operational mode in the initial SOC configuration (i.e., fixed single SOC configuration or fixed dual SOC configuration). In one example, when complete, return to block 920.

In block 930, determine if the initial SOC configuration is a single SOC configuration. If yes, proceed to block 931. If no, proceed to block 940.

In block 931, determine if the master SOC is an FF carrier mobility case or a SS carrier mobility case and if the slave SOC is a TT carrier mobility case. If yes, proceed to block 932. If no, proceed to block 933.

In block 932, move a portion of the master workload to the slave SOC to operate on an augmented slave workload. When complete, return to block 920.

In block 933, commence SOC operational mode in the initial SOC configuration (i.e., fixed single SOC configuration). When complete, return to block 920.

In block 940, determine if the master SOC is an FF carrier mobility case or a SS carrier mobility case and if the slave SOC is a TT carrier mobility case. If yes, proceed to block 941. If no, proceed to block 950.

In block 941, move a portion of the master workload to the slave SOC to operate on an augmented slave workload. When complete, return to block 920.

In block 950, determine if the master SOC is a TT carrier mobility case and if the slave SOC is a SS carrier mobility case or an FF carrier mobility case. If yes, proceed to block 951. If no, proceed to block 952.

In block 951, move a portion of the slave workload to the master SOC to operate on an augmented master workload. When complete, return to block 920.

In block 952, commence SOC operational mode in the initial SOC configuration (i.e., fixed dual SOC configuration). When complete, return to block 920.

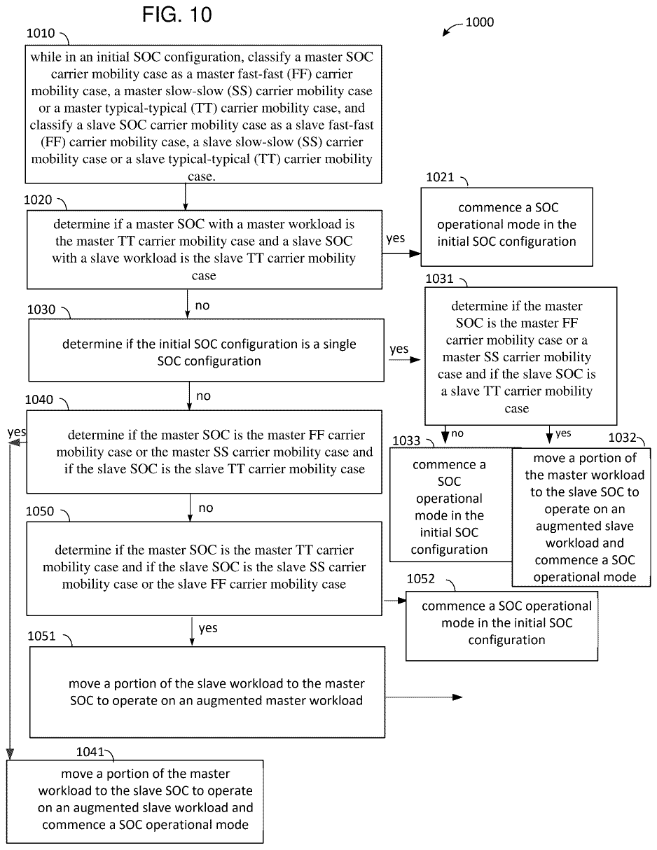

FIG. 10 illustrates an example flow diagram 1000 for implementing system on a chip (SOC) workload partitioning. In block 1010, while in an initial SOC configuration, classify a master SOC carrier mobility case as a master fast-fast (FF) carrier mobility case, a master slow-slow (SS) carrier mobility case or a master typical-typical (TT) carrier mobility case, and classify a slave SOC carrier mobility case as a slave fast-fast (FF) carrier mobility case, a slave slow-slow (SS) carrier mobility case or a slave typical-typical (TT) carrier mobility case. In one example, while in an initial SOC configuration, a master SOC carrier mobility case is classified as a master fast-fast (FF) carrier mobility case, a master slow-slow (SS) carrier mobility case or a master typical-typical (TT) carrier mobility case, and a slave SOC carrier mobility case is classified as a slave fast-fast (FF) carrier mobility case, a slave slow-slow (SS) carrier mobility case or a slave typical-typical (TT) carrier mobility case.

In one example, the classification is made prior to a SOC operational mode. In one example, the initial SOC configuration is a fixed single SOC configuration or a fixed dual SOC configuration. In one example, the master SOC carrier mobility case may be a fast-fast (FF) carrier mobility case, a typical-typical (TT) carrier mobility case or a slow-slow (SS) carrier mobility case. In one example, the slave SOC carrier mobility case may be the fast-fast (FF) carrier mobility case, the typical-typical (TT) carrier mobility case or the slow-slow (SS) carrier mobility case. In one example, the determination is achieved by retrieving carrier mobility case data from a memory. In one example, the memory is a bootup memory (e.g., read only memory (ROM)). In one example, the step in block 1010 may be performed by a central processing unit (CPU), a digital signal processor (DSP), a graphical processing unit (GPU), a display processing unit (DPU), a master system on a chip (SOC), a slave system on a chip (SOC), a controller, a microcontroller, a processing engine or combination thereof, etc.

In block 1020, determine if a master SOC with a master workload is the master TT carrier mobility case and a slave SOC with a slave workload is the slave TT carrier mobility case. In one example, whether a master SOC with a master workload is the master TT carrier mobility case is determined, and whether a slave SOC with a slave workload is the slave TT carrier mobility case is determined. In one example, the master TT carrier mobility case occurs if carrier mobility (values) for both a first semiconductor type and a second semiconductor type are within one standard deviation of a mean of the carrier mobility (values). In one example, the first semiconductor type is NMOS and the second semiconductor type is PMOS. If yes, proceed to block 1021. If no, proceed to block 1030. In one example, the step in block 1020 may be performed by a central processing unit (CPU), a digital signal processor (DSP), a graphical processing unit (GPU), a display processing unit (DPU), a master system on a chip (SOC), a slave system on a chip (SOC), a controller, a microcontroller, a processing engine or combination thereof, etc.

In block 1021, commence a SOC operational mode in the initial SOC configuration (i.e., fixed single SOC configuration or fixed dual SOC configuration). In one example, a SOC operational mode in the initial SOC configuration is commenced. In one example, when complete, return to block 1020.In one example, the step in block 1021 may be performed by a central processing unit (CPU), a digital signal processor (DSP), a graphical processing unit (GPU), a display processing unit (DPU), a master system on a chip (SOC), a slave system on a chip (SOC), a controller, a microcontroller, a processing engine or combination thereof, etc.

In block 1030, determine if the initial SOC configuration is a single SOC configuration. In one example, whether the initial SOC configuration is a single SOC configuration is determined. If yes, proceed to block 1031. If no, proceed to block 1040. In one example, the step in block 1030 may be performed by a central processing unit (CPU), a digital signal processor (DSP), a graphical processing unit (GPU), a display processing unit (DPU), a master system on a chip (SOC), a slave system on a chip (SOC), a controller, a microcontroller, a processing engine or combination thereof, etc.

In block 1031, determine if the master SOC is a master FF carrier mobility case or a master SS carrier mobility case and if the slave SOC is a slave TT carrier mobility case. In one example, whether the master SOC is a master FF carrier mobility case or a master SS carrier mobility case is determined, and whether the slave SOC is a slave TT carrier mobility case is determined.

In one example, the FF carrier mobility case occurs if carrier mobility (values) for both a first semiconductor type and a second semiconductor type are greater than one positive standard deviation of a mean of the carrier mobility (values). In one example, the master SS carrier mobility case occurs if carrier mobility (values) for both a first semiconductor type and a second semiconductor type are less than one negative standard deviation of a mean of the carrier mobility (values). If yes, proceed to block 1032. If no, proceed to block 1033. In one example, the step in block 1031 may be performed by a central processing unit (CPU), a digital signal processor (DSP), a graphical processing unit (GPU), a display processing unit (DPU), a master system on a chip (SOC), a slave system on a chip (SOC), a controller, a microcontroller, a processing engine or combination thereof, etc.

In block 1032, move a portion of the master workload to the slave SOC to operate on an augmented slave workload and commence a SOC operational mode. In one example, a portion of the master workload is moved to the slave SOC to operate on an augmented slave workload and commence a SOC operational mode. In one example, the augmented slave workload includes the slave workload and the portion of the master workload. In one example, when complete, return to block 1020. In one example, the step in block 1032 may be performed by a central processing unit (CPU), a digital signal processor (DSP), a graphical processing unit (GPU), a display processing unit (DPU), a master system on a chip (SOC), a slave system on a chip (SOC), a controller, a microcontroller, a processing engine or combination thereof, etc.

In block 1033, commence a SOC operational mode in the initial SOC configuration (i.e., fixed single SOC configuration). In one example, a SOC operational mode in the initial SOC configuration is commenced. In one example, when complete, return to block 1020. In one example, the step in block 1033 may be performed by a central processing unit (CPU), a digital signal processor (DSP), a graphical processing unit (GPU), a display processing unit (DPU), a master system on a chip (SOC), a slave system on a chip (SOC), a controller, a microcontroller, a processing engine or combination thereof, etc.

In block 1040, determine if the master SOC is the master FF carrier mobility case or the master SS carrier mobility case and if the slave SOC is the slave TT carrier mobility case. In one example, whether the master SOC is the master FF carrier mobility case or the master SS carrier mobility case is determined, and whether the slave SOC is the slave TT carrier mobility case is determined. If yes, proceed to block 1041. If no, proceed to block 1050. In one example, the step in block 1040 may be performed by a central processing unit (CPU), a digital signal processor (DSP), a graphical processing unit (GPU), a display processing unit (DPU), a master system on a chip (SOC), a slave system on a chip (SOC), a controller, a microcontroller, a processing engine or combination thereof, etc.

In block 1041, move a portion of the master workload to the slave SOC to operate on an augmented slave workload and commence a SOC operational mode. In one example, a portion of the master workload is moved to the slave SOC to operate on an augmented slave workload and a SOC operational mode is commenced. In one example, the augmented slave workload includes the slave workload and the portion of the master workload. In one example, when complete, return to block 1020. In one example, the step in block 1041 may be performed by a central processing unit (CPU), a digital signal processor (DSP), a graphical processing unit (GPU), a display processing unit (DPU), a master system on a chip (SOC), a slave system on a chip (SOC), a controller, a microcontroller, a processing engine or combination thereof, etc.

In block 1050, determine if the master SOC is the master TT carrier mobility case and if the slave SOC is the slave SS carrier mobility case or the slave FF carrier mobility case. In one example, whether the master SOC is the master TT carrier mobility case is determine, and whether the slave SOC is the slave SS carrier mobility case or the slave FF carrier mobility case is determined. If yes, proceed to block 1051. If no, proceed to block 1052. In one example, the step in block 1050 may be performed by a central processing unit (CPU), a digital signal processor (DSP), a graphical processing unit (GPU), a display processing unit (DPU), a master system on a chip (SOC), a slave system on a chip (SOC), a controller, a microcontroller, a processing engine or combination thereof, etc.

In block 1051, move a portion of the slave workload to the master SOC to operate on an augmented master workload. In one example, a portion of the slave workload is moved to the master SOC to operate on an augmented master workload. In one example, the augmented master workload includes the master workload and the portion of the slave workload. In one example, when complete, return to block 1020. In one example, the step in block 1051 may be performed by a central processing unit (CPU), a digital signal processor (DSP), a graphical processing unit (GPU), a display processing unit (DPU), a master system on a chip (SOC), a slave system on a chip (SOC), a controller, a microcontroller, a processing engine or combination thereof, etc.

In block 1052, commence a SOC operational mode in the initial SOC configuration (i.e., fixed dual SOC configuration). In one example, a SOC operational mode in the initial SOC configuration is commenced. In one example, when complete, return to block 1020. In one example, the step in block 1052 may be performed by a central processing unit (CPU), a digital signal processor (DSP), a graphical processing unit (GPU), a display processing unit (DPU), a master system on a chip (SOC), a slave system on a chip (SOC), a controller, a microcontroller, a processing engine or combination thereof, etc.

In one example, the present disclosure discloses a method including: determining if an initial system on a chip (SOC) configuration is a single SOC configuration; determining if a master system on a chip (SOC) is a master fast-fast (FF) carrier mobility case or a master slow-slow (SS) carrier mobility case; and determining if a slave system on a chip (SOC) is a slave typical-typical (TT) carrier mobility case.

In one example, the method further includes: determining if the master SOC is a master typical-typical (TT) carrier mobility case: and determining if the slave SOC is a slave slow-slow (SS) carrier mobility case or a slave fast-fast (FF) carrier mobility case. In one example, the method further includes commencing a system on a chip (SOC) operational mode in the initial SOC configuration. In one example, the method further includes moving a portion of a slave workload to the master SOC to operate on an augmented master workload. In one example, the augmented master workload includes a master workload and the portion of the slave workload.

In one example, the method further includes moving a portion of a master workload to the slave SOC to operate on an augmented slave workload; and commencing a system on a chip (SOC) operational mode. In one example, the augmented slave workload includes a slave workload and the portion of the master workload.

In one example, the method further includes commencing a system on a chip (SOC) operational mode in the initial SOC configuration In one example, the method further includes moving a portion of a master workload to the slave SOC to operate on an augmented slave workload; and commencing a system on a chip (SOC) operational mode. In one example, the augmented slave workload includes a slave workload and the portion of the master workload.

In one example, the method further includes: while in an initial system on a chip (SOC) configuration, classify a master SOC carrier mobility case as the master fast-fast (FF) carrier mobility case, the master slow-slow (SS) carrier mobility case or a master typical-typical (TT) carrier mobility case; and while in the initial SOC configuration, classify a slave SOC carrier mobility case as a slave fast-fast (FF) carrier mobility case, a slave slow-slow (SS) carrier mobility case or the slave typical-typical (TT) carrier mobility case.

In one example, the master fast-fast (FF) carrier mobility case occurs if carrier mobility for both a first semiconductor type and a second semiconductor type are greater than three positive standard deviations of a mean of the carrier mobility. In one example, the master slow-slow (SS) carrier mobility case occurs if carrier mobility for both a first semiconductor type and a second semiconductor type are less than three negative standard deviations of a mean of the carrier mobility. In one example, the master typical-typical (TT) carrier mobility case occurs if carrier mobility for both a first semiconductor type and a second semiconductor type are within one standard deviation of a mean of the carrier mobility.

In one example, the method further includes: determining if the master SOC with a master workload is the master TT carrier mobility case; and determining if the slave SOC with a slave workload is the slave TT carrier mobility case. In one example, the method further includes commencing a system on a chip (SOC) operational mode in the initial SOC configuration.

In one example, the master SOC is further configured to move a portion of the master workload to the slave SOC to operate on an augmented slave workload and is further configured to commence a system on a chip (SOC) operational mode. In one example, the augmented slave workload includes a slave workload and the portion of the master workload.

In one aspect, one or more of the steps for providing system on a chip (SOC) workload partitioning in FIG. 10 may be executed by one or more processors which may include hardware, software, firmware, etc. The one or more processors, for example, may be used to execute software or firmware needed to perform the steps in the flow diagram of FIG. 10. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

The software may reside on a computer-readable medium. The computer-readable medium may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium may also include, by way of example, a carrier wave, a transmission line, and any other suitable medium for transmitting software and/or instructions that may be accessed and read by a computer. The computer-readable medium may reside in a processing system, external to the processing system, or distributed across multiple entities including the processing system. The computer-readable medium may be embodied in a computer program product. By way of example, a computer program product may include a computer-readable medium in packaging materials. The computer-readable medium may include software or firmware. Those skilled in the art will recognize how best to implement the described functionality presented throughout this disclosure depending on the particular application and the overall design constraints imposed on the overall system.

Any circuitry included in the processor(s) is merely provided as an example, and other means for carrying out the described functions may be included within various aspects of the present disclosure, including but not limited to the instructions stored in the computer-readable medium, or any other suitable apparatus or means described herein, and utilizing, for example, the processes and/or algorithms described herein in relation to the example flow diagram.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another—even if they do not directly physically touch each other. The terms “circuit” and “circuitry” are used broadly, and intended to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure.

One or more of the components, steps, features and/or functions illustrated in the figures may be rearranged and/or combined into a single component, step, feature or function or embodied in several components, steps, or functions. Additional elements, components, steps, and/or functions may also be added without departing from novel features disclosed herein. The apparatus, devices, and/or components illustrated in the figures may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for.”

One skilled in the art would understand that various features of different embodiments may be combined or modified and still be within the spirit and scope of the present disclosure.

What is claimed is:

1. A method comprising:
determining if an initial system on a chip (SOC) configuration is a single SOC configuration;
determining if a master system on a chip (SOC) is a master fast-fast (FF) carrier mobility case or a master slow-slow (SS) carrier mobility case; and
determining if a slave system on a chip (SOC) is a slave typical-typical (TT) carrier mobility case.

2. The method of claim 1, further comprising:
determining if the master SOC is a master typical-typical (TT) carrier mobility case: and
determining if the slave SOC is a slave slow-slow (SS) carrier mobility case or a slave fast-fast (FF) carrier mobility case.

3. The method of claim 2, further comprising commencing a system on a chip (SOC) operational mode in the initial SOC configuration.

4. The method of claim 2, further comprising moving a portion of a slave workload to the master SOC to operate on an augmented master workload.

5. The method of claim 4, wherein the augmented master workload includes a master workload and the portion of the slave workload.

6. The method of claim 1, further comprising
moving a portion of a master workload to the slave SOC to operate on an augmented slave workload; and
commencing a system on a chip (SOC) operational mode.

7. The method of claim 6, wherein the augmented slave workload includes a slave workload and the portion of the master workload.

8. The method of claim 1, further comprising commencing a system on a chip (SOC) operational mode in the initial SOC configuration.

9. The method of claim 1, further comprising:
moving a portion of a master workload to the slave SOC to operate on an augmented slave workload; and
commencing a system on a chip (SOC) operational mode.

10. The method of claim 9, wherein the augmented slave workload includes a slave workload and the portion of the master workload.

11. The method of claim 1, further comprising:
while in an initial system on a chip (SOC) configuration, classify a master SOC carrier mobility case as the master fast-fast (FF) carrier mobility case, the master slow-slow (SS) carrier mobility case or a master typical-typical (TT) carrier mobility case; and
while in the initial SOC configuration, classify a slave SOC carrier mobility case as a slave fast-fast (FF) carrier mobility case, a slave slow-slow (SS) carrier mobility case or the slave typical-typical (TT) carrier mobility case.

12. The method of claim 11, wherein the master fast-fast (FF) carrier mobility case occurs if carrier mobility for both a first semiconductor type and a second semiconductor type are greater than one positive standard deviation of a mean of the carrier mobility.

13. The method of claim 11, wherein the master slow-slow (SS) carrier mobility case occurs if carrier mobility for both a first semiconductor type and a second semiconductor type are less than one negative standard deviation of a mean of the carrier mobility.

14. The method of claim 11, wherein the master typical-typical (TT) carrier mobility case occurs if carrier mobility for both a first semiconductor type and a second semiconductor type are within one standard deviation of a mean of the carrier mobility.

15. The method of claim 11, further comprising:
determining if the master SOC with a master workload is the master TT carrier mobility case; and
determining if the slave SOC with a slave workload is the slave TT carrier mobility case.

16. The method of claim 15, further comprising commencing a system on a chip (SOC) operational mode in the initial SOC configuration.

17. An apparatus comprising:
a non-transitory memory unit configured to store a master workload and a slave workload;
a slave system on a chip (SOC) coupled to the non-transitory memory unit, the slave SOC configured to process the slave workload; and
a master system on a chip (SOC) coupled to the non-transitory memory unit, the master SOC configured to determine if the master SOC is a master fast-fast (FF) carrier mobility case or a master slow-slow (SS) carrier mobility case and further configured to determine if the slave SOC is a slave typical-typical (TT) carrier mobility case.

18. The apparatus of claim 17, wherein the master SOC is further configured to move a portion of the master workload to the slave SOC to operate on an augmented slave workload and is further configured to commence a system on a chip (SOC) operational mode.

19. The apparatus of claim 18, wherein the augmented slave workload includes a slave workload and the portion of the master workload.

20. An apparatus comprising:
means for determining if a master system on a chip (SOC) with a master workload is a master typical-typical (TT) carrier mobility case;
means for determining if a slave system on a chip (SOC) with a slave workload is a slave typical-typical (TT) carrier mobility case;
means for determining if an initial system on a chip (SOC) configuration is a single SOC configuration;
means for determining if the master SOC is a master fast-fast (FF) carrier mobility case or a master SS carrier mobility case;
means for determining if the slave SOC is the slave TT carrier mobility case;
means for determining if the master SOC is the master TT carrier mobility case;
means for determining if the slave SOC is a slave SS carrier mobility case or a slave fast-fast (FF) carrier mobility case; and
means for moving a portion of the slave workload to the master SOC to operate on an augmented master workload.
